(19) United States
(12) Patent Application Publication
(10) Pub. No.: US 2024/0360839 A1
(43) Pub. Date: Oct. 31, 2024

(54) CLOSED CYCLE LIFT FORCE TURBINE

(71) Applicant: Orville J. Birkestrand, Davenport, IA (US)

(72) Inventor: Orville J. Birkestrand, Davenport, IA (US)

(21) Appl. No.: 18/735,942

(22) Filed: Jun. 6, 2024

Related U.S. Application Data
(63) Continuation-in-part of application No. 18/241,724, filed on Sep. 1, 2023.
Application No. 18/241,724 is a continuation-in-part of application No. 17/186,739, filed on Feb. 26, 2021, now Pat. No. 11,781,521.
(60) Provisional application No. 62/982,421, filed on Feb. 27, 2020.

(51) Int. Cl. F04D 29/44; F01D 15/10; F04D 17/10

(52) U.S. Cl. CPC F04D 29/441; F01D 15/10; F04D 17/10

(57) ABSTRACT

A closed cycle lift force turbine is provided that comprises a lift turbine, an input stator, and a centrifugal compressor. The closed cycle lift force turbine may be utilized to generate continuous thrust, heat and/or electricity for powering vehicles at any speed in any atmosphere or lack thereof.

### CROSS-REFERENCE TO RELATED APPLICATIONS

The present application is a continuation-in-part of commonly assigned copending U.S. patent application Ser. No. 18/241,724, which was filed on Sep. 1, 2023, by Orville J. Birkestrand for OPEN AND CLOSED CYCLE LIFT FORCE TURBINES, which is a continuation-in-part of commonly assigned copending U.S. patent application Ser. No. 17/186,739, which was filed on Feb. 26, 2021, by Orville J. Birkestrand for TOROIDAL LIFT FORCE ENGINE, which claims the benefit of priority to U.S. Provisional Patent Application Ser. No. 62/982,421, filed on Feb. 27, 2020 entitled TOROIDAL LIFT FORCE ENGINE, by Orville J. Birkestrand, which applications are hereby incorporated by reference.

The present application is related to: U.S. patent application Ser. No. 13/729,205, filed on Dec. 28, 2012 entitled POWER GENERATION APPARATUS, issued on Nov. 14, 2017 as U.S. Pat. No. 9,816,383; U.S. patent application Ser. No. 14/141,986, filed on Dec. 27, 2013 entitled POWER GENERATION APPARATUS, issued on Nov. 14, 2017 as U.S. Pat. No. 9,816,384; and U.S. patent application Ser. No. 15/482,313, entitled WIND TURBINE filed on Apr. 7, 2017, all by Orville J. Birkestrand, the contents of each are hereby incorporated by reference.

### BACKGROUND

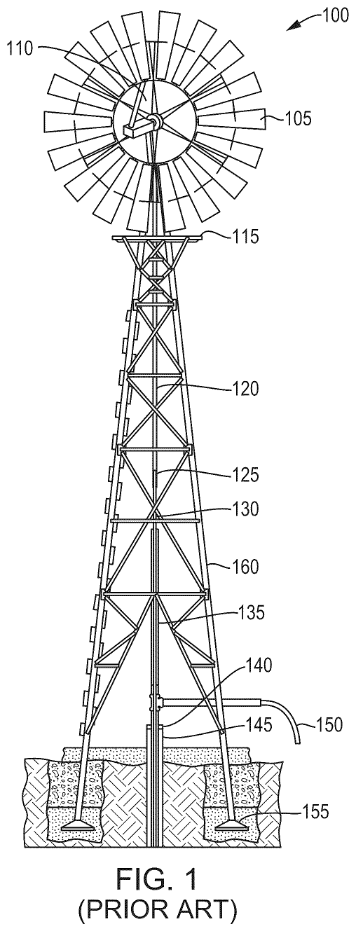

FIG. 1 is a front view of an exemplary prior art farm windmill 100 that is well known to those skilled in the art. The windmill 100 includes a plurality (typically 18) of blades 105 that are configured in a substantially circular arrangement and operatively interconnected with a gearbox 110. A platform 115 is arranged slightly below the bottom level of the blades 105 to enable easy access to the blades 105 and/or the gearbox 110 for maintenance purposes, etc. The gearbox 110 is operatively interconnected with a pump pole 120 which terminates in a connector 125. Connector 125 is further interconnected with a pump rod 130 that is encased by a standpipe 135 that extends into a well 140. Typically, well casing 145 surrounds the entry into well 140 and provides support for a discharge point 150.

A windmill tower 160 provides structural support so that the blades 105 are located at a substantial height above the ground to enable wind to reach them without obstructions from buildings, terrain, etc. The tower 160 also provides support to counteract the forces caused by the blades 105 rotating in the wind, which may be a lateral force that could cause the windmill to tip over if the wind reaches a sufficient velocity. As such, windmills 100 typically are configured to rotate out of the wind in the event that the wind speed reaches a predetermined threshold. This protects the blades 105 and tower 160 from damage and/or destruction caused by the blades rotating at too high a speed and/or generating too much lateral force on the tower 160.

In operation, the wind causes the blades 105 to spin, thereby turning the gearbox 110, which activates the pump via the pump rod 130 to provide a conventional pumping mechanism to draw water from the well's reservoir to be discharged out the discharge point 150. As will be appreciated by those skilled in the art, the farm windmill 100 is typically limited to pumping water (or other fluid). A conventional farm windmill 100 is further limited to certain wind speeds and has an extremely low efficiency at higher wind speeds. This higher wind speed low efficiency results from their primary design to preferably produce torque at low wind speeds to supply sole source water on even nearly windless days to distant and dependent animals.

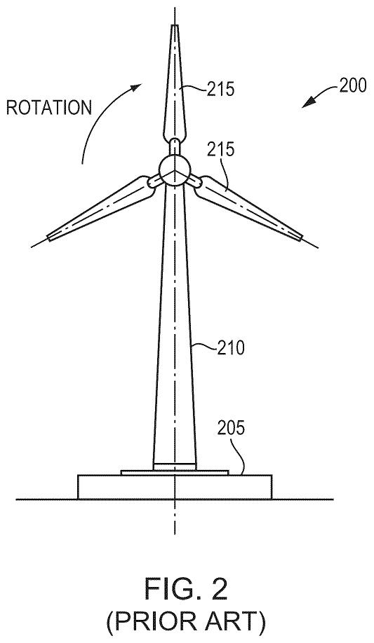

FIG. 2 is an exemplary front perspective view of a modern prior art wind turbine 200 that may be utilized for power generation. Since the power of the wind varies as the cube of its speed, utility scale wind turbines, which tend to rotate at near constant speeds to meet grid frequency requirements, are primarily designed to extract power at the rarer but much more powerful higher wind speeds, largely ignoring capturing power at lower wind speeds. The wind turbine 200 comprises a plurality (typically three) of blades 215 that are mounted on a hub that is supported by a tower 210. Typical modern wind turbines are mounted at heights on the order of tens of meters (e.g., 90 meters) with blades that are also on the order of tens of meters long. Modern wind turbines 200 often encase all operating components within the tower 210 or within the supporting base 205. As such, external views of the wind turbine do not display its operation as it does for a conventional farm windmill 100.

A noted disadvantage of modern wind turbines 200 is that they typically do not include a separate mechanism to prevent stalling of the wind turbine should the wind flow slow down or should a high speed spike occur over the blades 215. Commonly, such micro stalls occur due to, e.g., momentary spikes and/or lulls in the wind flowing over the blades 205 of the turbine 200. Without a mechanism to combat such spikes or stalls, the overall efficiency of the wind turbine 200 is significantly further reduced. Modern wind turbines do not have a simple control system to actively automatically track the rotor's rotations per minute (RPM) in relation to the wind's instantaneous speed to maintain the desired wind attack angle at all times. Instead, they commonly operate at approximately one speed (RPM) to generate a required grid frequency. More recent machines may be equipped with elaborate and expensive electronic control systems which permit modest speed variations on the order of ±20%. Such control limitations limit their possible maximum efficiencies. Additionally, they have to operate as tip speed ratios (TSR's) of 6 or more with their blade chords at the rotor tip in the plane of the rotor, so that they are not back winded and stopped when the wind suddenly stalls, as they would with the ever present and unavoidable atmospheric turbulences.

Conventional three-bladed windmills/wind turbines capture only the tangential portion of the lift force, or about 6%, of the total lift forces generated because they normally operate at a TSR of 6 or more. The remainder or normal component of the lift forces is counteracted by trying to overturn the tower and is consequently completely unutilized. This causes exemplary towers 160, 210 and/or foundations 205 to be overbuilt in order to prevent the tower from being tipped over. Further, conventional windmills illustratively capture none of the possible productive forces to produce useful power from the flow from one blade enhancing the flow over other neighboring blades.

Under conventional thinking, all wind machines are limited by the Betz law that states that no turbine can capture more than 16/27 (59.3%) percent of the kinetic energy in the wind. This factor 16/27 (or 0.593) is known as the Betz limit. Conventional state of art three bladed windmills, which only capture a portion of the tangential lift forces or approximately 6% of the total, currently peak at approximately 75 to 80% of the Betz limit. The Betz limit claims to produce a theoretical upper bound amount of energy that may be extracted at any particular windmill site and is reasonable for drag type forces but does not apply to lift type forces. Even assuming (hypothetically) that the wind blew in a particular location continuously, according to conventional wisdom, no more than the Betz limit of the kinetic energy obtained in that year's wind may be extracted in keeping with common experience; however, this may be coincidence of the maximum possible with a three bladed conventional machine. In practice, most current systems do not reach a performance rate of even 50% of the Betz limit and none of them capture any portion of the far greater Normal component Lift Forces. The vast majority have typical rates of between 20% to 40% of the Betz limit.

A further noted disadvantage of modern wind turbine operation is that their relatively rapidly rotating rotor blades foul the surrounding air, making adding more blades not productive, and typically produce annoying sounds. Further, they may be a danger to flying animals, such as birds. For these and other reasons, conventional wind turbines are not practical or desirable for use in or near urban/suburban neighborhoods where the vast amount of power is consumed. Rather, they are typically placed in large groups (i.e., wind farms) at locations where they may be serviced efficiently and where they are exposed to higher velocity winds. As a result, they require extensive transmission systems to carry the generated electricity to where it is needed.

Further, for all prior art wind machines, their energy harvested does not increase faster than D², where D is the diameter of the blades. An additional major disadvantage of prior art wind turbines is that they operate of tip speed ratios (TSRs) of 6 or more, which requires that they must be located on exceptionally tall towers to reach not only faster moving winds but also to reach less turbulent winds. Consequently, they are recommended to be located a substantial distance (e.g., 500+ feet) from any obstructions, such as trees, buildings, or other wind machines in order to function properly. Further, with TSRs of 6 or more, should a wind gust come along and lower the TSR to, e.g., 5 or less, a conventional 3-bladed wind turbine typically will have flow separation and loss of power due to a micro-stall occurring as they have no mechanism of coarse tracking of the wind's speed nor limiting the range of possible attack gusts changing the attack angle of the apparent wind on their blades, thereby reducing the possible captured power.

In summary, while both the farm windmill and the conventional 3-bladed utility scale wind machines are commercially successful at their tasks, they do not have the optimum blade array for high speed and/or high-power general-purpose turbine/engines. This is due to the fact that the farm windmill, which is specifically designed to efficiently produce useful power at low wind speeds, operates over a limited low wind speed range of about 6-18 MPH with a TSR of about 1.25 or less in order to consistently generate torque and pump water at low, but turbulent wind speeds. Above TSR's of about 1.25, its blades are back winded by the normally present turbulent nulls, preventing them from ever reaching higher TSR's and resulting in higher power levels. The 3-bladed machines, designed to produce maximum power from a given site installation irrespective of various needs at low wind speeds, operating at TSR's of 6 or more, also to accommodate the ever-present turbulent winds, operating over a wind speed range of approximately 11-25 MPH, already have their blade tip speeds nearing the speed of sound at these low wind speeds, becoming increasingly noisy. They clearly are not candidates for machines operating at wind speeds of say 50 to 750 MPH, as their blade tip speeds, would have to be 6 or more times that. Additionally, these machines foul the surrounding air and only productively interact with perhaps approximately 5% of the molecules passing through their blade disc. Further, neither of these machines are equipped to properly regulate and/or control the wind's angle of attack (a) upon their blades in real time, making them unsuitable for a general purpose engine application. What is required is a machine that can control a in real time, operate at TSR's of about 1.00-6 over a speed range of about 10:1.

Finally, and perhaps most importantly, the only harvestable energies with the old farm style as well as the modern wind turbine are from the tangential part of the lift forces. The normal part of the lift force, which works to cause the tower to tip over, is several times, even as much as an order of magnitude larger, more powerful and is unutilized and wasted. Additionally, wind power is notoriously intermittent, necessitating costly investments in backup/gap filling power systems.

Gas jet engines have their own problems and limitations. For example, they are extremely complex and require some of the most advanced and sophisticated engineering and manufacturing talents and techniques, which often drives their costs up and beyond $1-5,000 per pound. Additionally, to reach maximum efficiencies, some of todays' engines approach internal temperatures of 3,100 degrees Fahrenheit, drastically limiting their useful life before necessary major and costly overhauls are required. To operate at these temperatures requires some of the most exotic, expensive, and rarest materials available. Further, modern jet fighters, like the F-35, which utilizes the Pratt & Whitney F135 engine, burn fuels up to 0.70 lb/lbt/hr cruising @ 28,000 lbt or 19,600 lb/hr to 2.0 lb./lbt/hr with after burner @ 43,000 lb. thrust or approximately 86,000 lb. fuel per hour, costing approximately $19,600 or $86,000 per hour respectively, at $1.00/lb, but varies depending upon the widely varying local price of fuel. That is, every hour and one half of cruising flight time, the F35 burns its empty weight in fuel. A Boeing 747 reportedly burns approximately 3,600 gallons of fuel per hour while cruising, costing about $24,120. per hour. Sustainable Aviation Fuels (SAF) reportedly cost approximately 1.5-10 times current jet fuel prices. Finally, each gallon of jet fuel burned reportedly produces 21.1 lb. of CO₂. Business and commercial aviation alone reportedly produces approximately 2.5% of worldwide CO₂ pollution, or about one billion tons, per year. Travel by airplane is reportedly the most polluting means of travel and the one that generates the most greenhouse gas emissions. This is not sustainable.

All current gas jet turbines need to operate in an atmosphere containing sufficient oxygen to burn fuel to provide thrust and the furthermore the different types are efficient at only a limited range of vehicle speeds and/or altitudes. They also require exotic materials to operate in high temperatures to be efficient as well as transport significant volumes/weight of fuel, which significantly limits their acceleration/deceleration as well as general flight performance and range.

A typical gas fired electrical utility would have multiples of similar engines running 24/7/365, with the United States of America alone having an estimated 3,000 electric utilities. The costs and pollutants resulting clearly contribute to inequality as well as climate change and/or health issues.

Power boat users have long been groomed to believe that they must burn something to get from point A to point B. Originally it was dung or wood, but then it progressed to coal, then oil to gas. Even now, some believe that an exotic nuclear fuel must be “burned” to get from A to B. To this day, this mindset has permeated designers and theoreticians of not only power boats of all sizes, but also carried over into power generation in general as well as vehicles of all types including cars, trucks, buses, airplanes and especially rockets, unlike seemingly every galactic alien neighbor from fiction. This contrasts to sailboat people who have known all along that Lift Forces alone can get them wherever they wish to go and often faster.

### SUMMARY

The above and other disadvantages of the prior art are overcome by a closed cycle lift force turbine (CCLFT) in accordance with illustrative embodiments of the present invention. Unlike the gas jet turbine, the closed cycle lift force turbine illustratively operates independent of any local atmosphere and/or the speed of the vehicle in which it is mounted, as it utilizes the normal component of its lift forces to generate direct thrust, without expelling any particles of any kind with the tangential component providing additional thrust force and/or providing other inboard power, heat, and/or air conditioning as desired. The closed cycle lift force turbine is illustratively comprised of a lift turbine stator, a lift turbine, and a centrifugal compressor and associated guideway.

The inlet to the centrifugal compressor is illustratively located immediately after the lift turbine. The inlet creates a low-pressure region sucking the flow out of the lift turbine, speeding it up to a maximum at its outermost point where it enters the diffuser which converts this high velocity kinetic energy into higher pressure, lower velocity potential energy as it travels through an outside return path towards the lift turbine. This flow later expands in the most useful region, the very blade region that produces the most dramatic asymmetrical pressure differential, as it passes through the relatively small gap between the training edge of one blade energizing the boundary layer of its succeeding blade in the very area where flow from high angles of attack is most likely to separate from the working blade allowing it to momentarily function at higher-than-normal angles of attack. On the side of the lower lift turbine structure facing the input to the centrifugal compressor are radial ribs that help bring the rotating fluid's velocity up to the rotations per minute (RPM) of the input to the centrifugal compressor.

Illustratively, high fluid velocities only exist in two places within the system: (1) where they are created at the exit from the centrifugal compressor, and (2) around the high lift areas of the working blades where they are used. In all other areas, primarily to reduce frictional flow loses, this velocity is lowered, either by being converted into potential energy or geometry to minimize potential fluid velocity frictional flow loses. Additionally, this flow conversion from high velocities to potential energies reduces the necessary size of the various channels, reducing the size and weight of the machine and therefore allowing the increase to its energy density, as well as reduce its manufacturing cost.

In accordance with illustrative embodiments of the present invention, a direct drive embodiment is presented where the lift turbine and the centrifugal compressor are pressed onto the same shaft. These components therefore rotate as one piece. In an alternative embodiment, these parts are on colinear shafts separated by a ball bearing, allowing them to rotate at different RPM's, to enhance and/or modify a particular performance. This “vari-drive” embodiment, in addition to varying the systems' internal pressure, enables the system to find a “sweet spot” in a particular machine and/or allows varying the tangential and/or the normal component power output, while maintaining a constant speed turbine RPM, as is usually desirable with a constant frequency electric grid connected machine or appliances requiring same. The simplest direct drive embodiment illustratively has only one hydraulic pump/motor for input/output, whereas vari-drive embodiments may have two or more input/outputs, e.g. hydraulic units, connected in various ways depending upon desired functions.

Any of the input/outputs could employ a gear box (or not) to achieve higher power levels and/or densities depending upon desired circumstances as well as being pressurized to suit desired energy densities. Also, the pivot mounts for thrust directional control can be added at any time to the various units as required/desired.

The closed cycle lift force turbine may provide a thrust force, without expelling particles of any kind, independent of the surrounding atmosphere, whether gaseous, liquid or the void of outer space. A suitable vehicle powered by same, can of course readily traverse all of these mediums seamlessly and do so without significant electromagnetic, heat, light, exhaust and/or sound signatures. By mounting a closed cycle lift force turbine in a vehicle, the thrust may be used to accelerate and or decelerate to propel the vehicle to any speed desired. Since this thrust force does not involve burning oxygen it is independent of the chemical components of the outside atmosphere or lack thereof, e.g., the void of space. Further, a closed cycle lift force turbine would operate equally well on the surface of a planet with or without oxygen in its atmosphere.

Illustratively, a closed cycle lift force turbine may be mounted in an aircraft similarly to and replacing a gas jet engine. Before and during normal flight take off operations, the battery powered electric starter-generator in the hydraulic circuit drives the Lift Turbines' hydraulic motor/pump until the Lift Turbine gets up to speed, powering the vehicle while cruising thereby saving substantial fuel as well as pollution costs. The thrust generated by the closed cycle high speed lift force turbine provides sufficient thrust for straight and level/cruising flight operations, extending its range. Further, more powerful, but not necessarily larger Lift Force Turbines could eliminate the need for the gas jet turbine or internal combustion engine altogether. Further, the Tangential component of the rotation of the lift turbine of a closed cycle lift force turbine may be used to power a pump configured to pump a fluid, such as hydraulic fluid, which may be used to power hydraulic motors, heat exchangers, generators, etc. In this manner, a closed cycle lift force turbine may be used additionally to power the vehicle, with electricity, hot water, heat, and/or air conditioning.

### BRIEF DESCRIPTION OF THE DRA WINGS

The above and further advantages of the present invention are described in connection with the accompanying drawings in which like reference numerals indicate identical or functionally equivalent elements:

FIG. 1, previously described, is a front view of an exemplary farm windmill as is known in the prior art;

FIG. 2, previously described, is a front view of an exemplary three-bladed wind turbine as is known in the prior art;

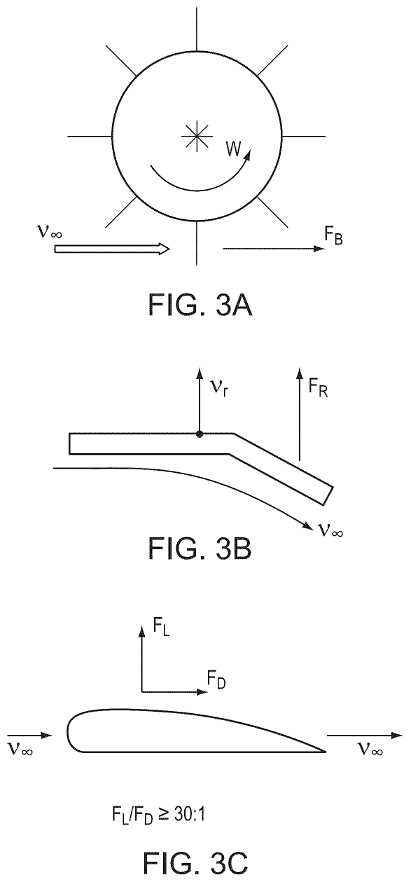

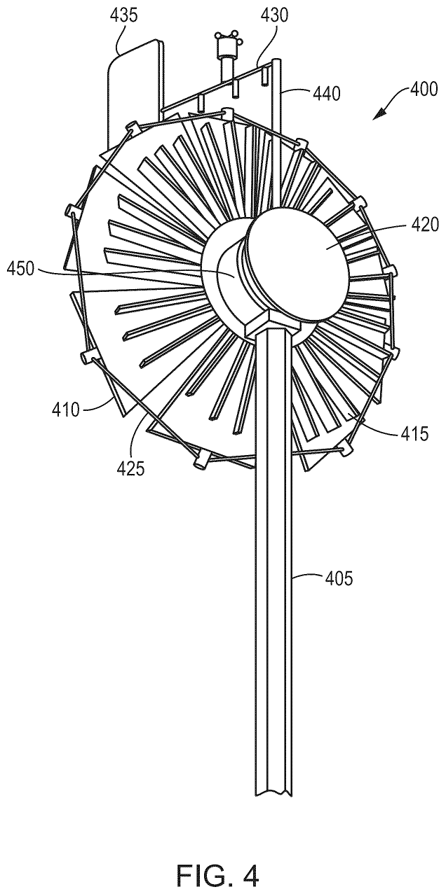

FIG. 3A is a diagram illustrating the Bernoulli force with a rotating device;

FIG. 3B is a diagram illustrating reaction force with an angled surface;

FIG. 3C is a diagram illustrating lift force over a blade;

FIG. 4 is a perspective view of an illustrative horizontal axis lift turbine (HALT) in accordance with an illustrative embodiment of the present invention;

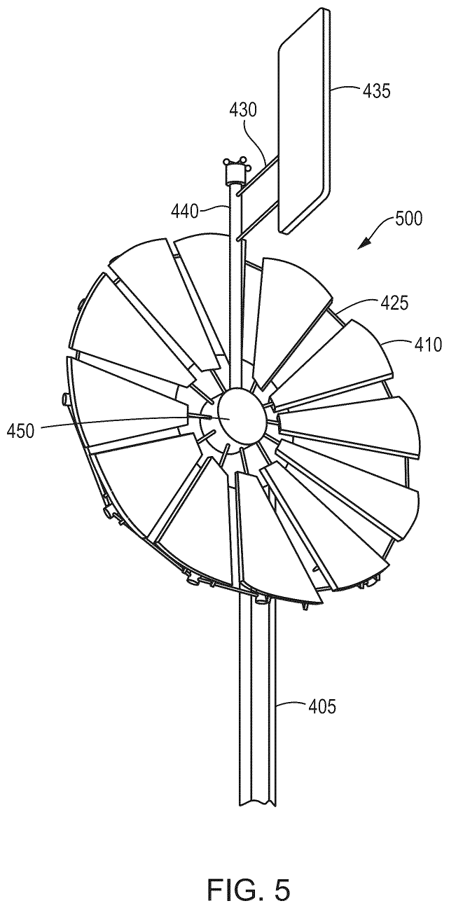

FIG. 5 is a rear perspective view of an exemplary HALT in accordance with an illustrative embodiment of the present invention;

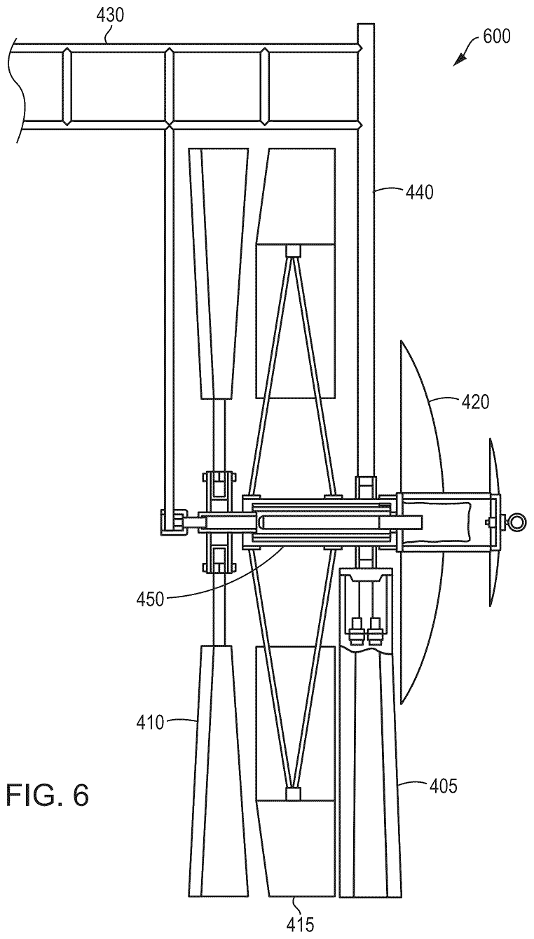

FIG. 6 is a side view of an exemplary HALT in accordance with an illustrative embodiment of the present invention;

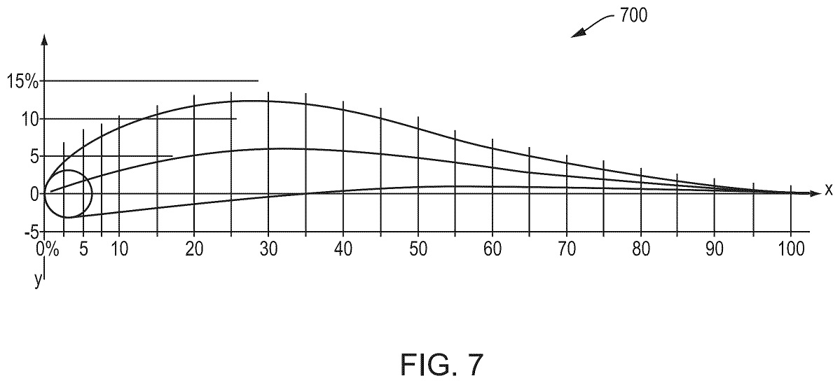

FIG. 7 is a cross-sectional view of an exemplary HALT blade in accordance with an illustrative embodiment of the present invention;

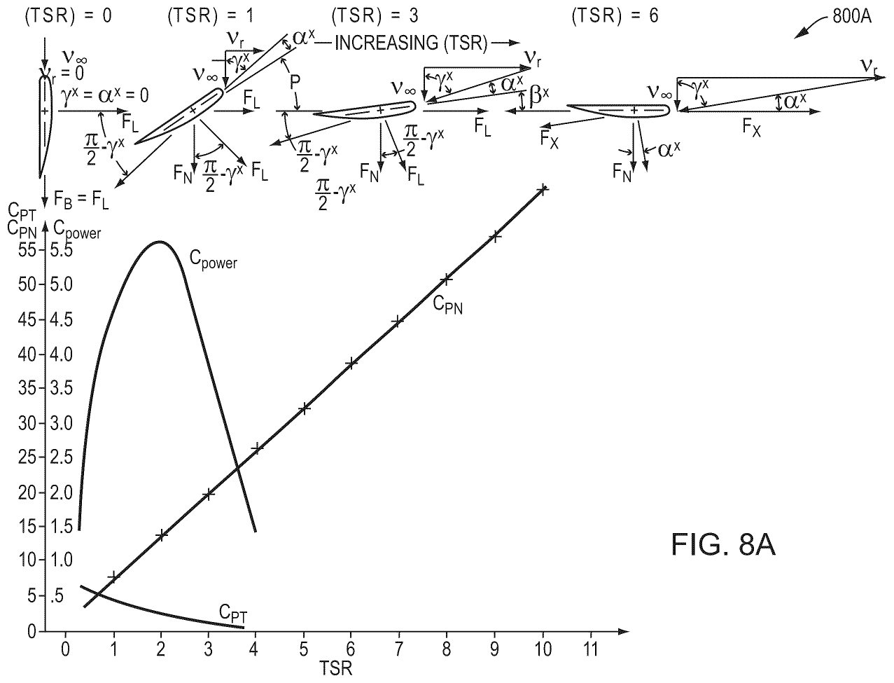

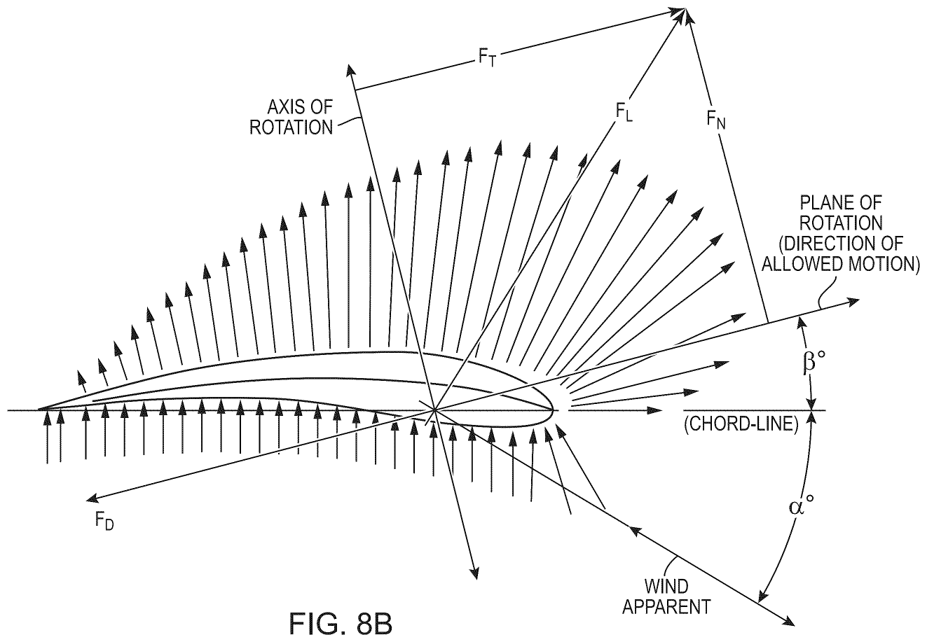

FIG. 8A is an exemplary chart illustrating the relationship among power torque and the distribution of lift force into the normal and tangential components with tip speed ratio (TSR) in accordance with an illustrative embodiment of the present invention;

FIG. 8B is an illustration of an exemplary lift force blade's pressure distribution in accordance with an illustrative embodiment of the present invention;

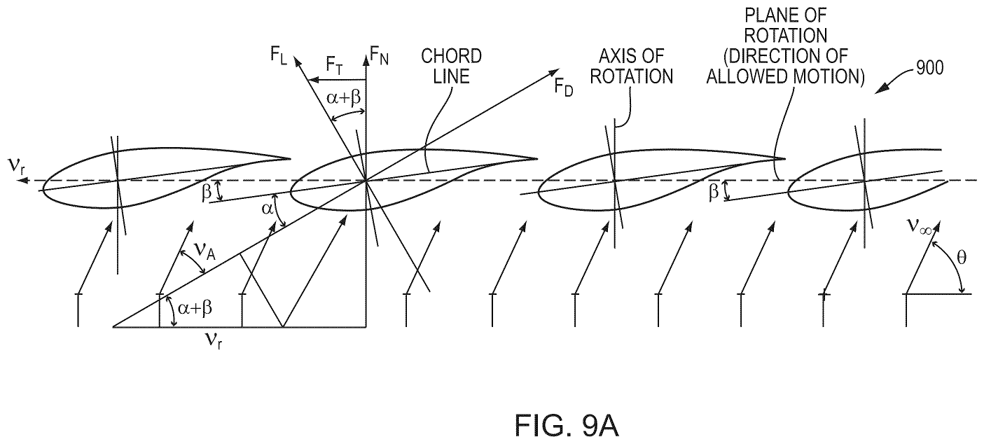

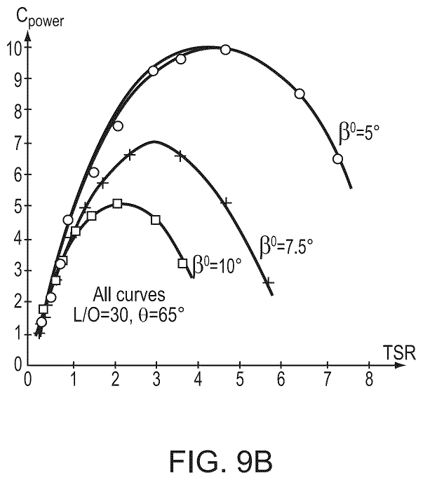

FIG. 9A is an exemplary diagram illustrating blade and related stator layout in accordance with an illustrative embodiment of the present invention;

FIG. 9B is an exemplary chart illustrating the relationship between TSR, Beta (B) and power in accordance with an illustrative embodiment of the present invention;

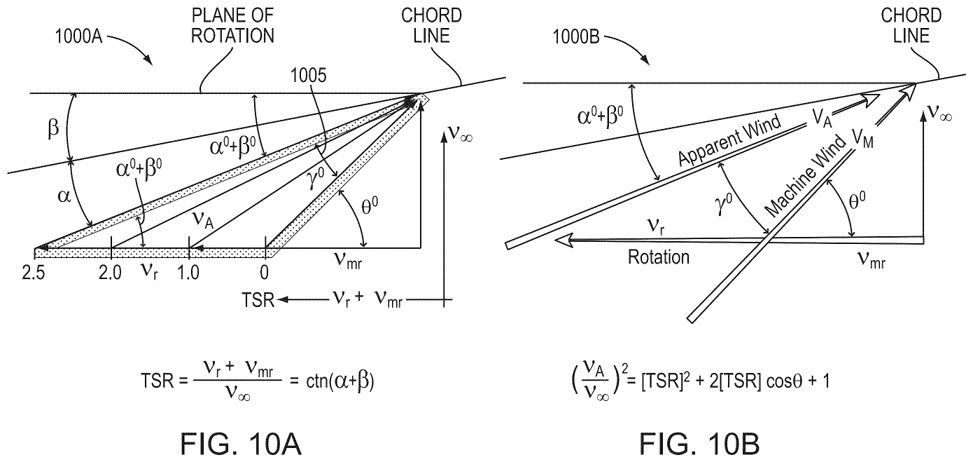

FIG. 10A is an exemplary force diagram for a golden triangle and compression of alpha (x) the angle of attack, in accordance with an illustrative embodiment of the present invention;

FIG. 10B is an exemplary force diagram of a lift turbine blade in accordance with an illustrative embodiment of the present invention;

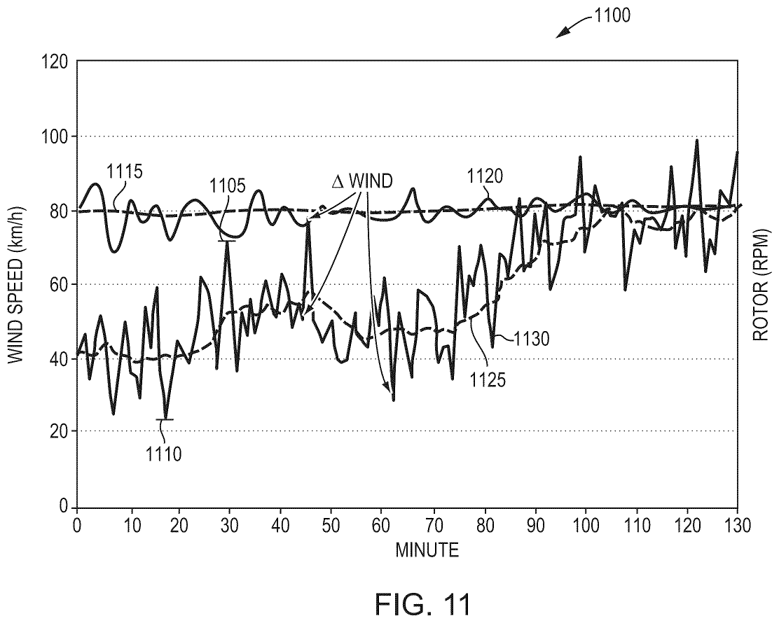

FIG. 11 is a chart illustrating momentary spikes and lulls in wind speed in accordance with an illustrative embodiment of the present invention;

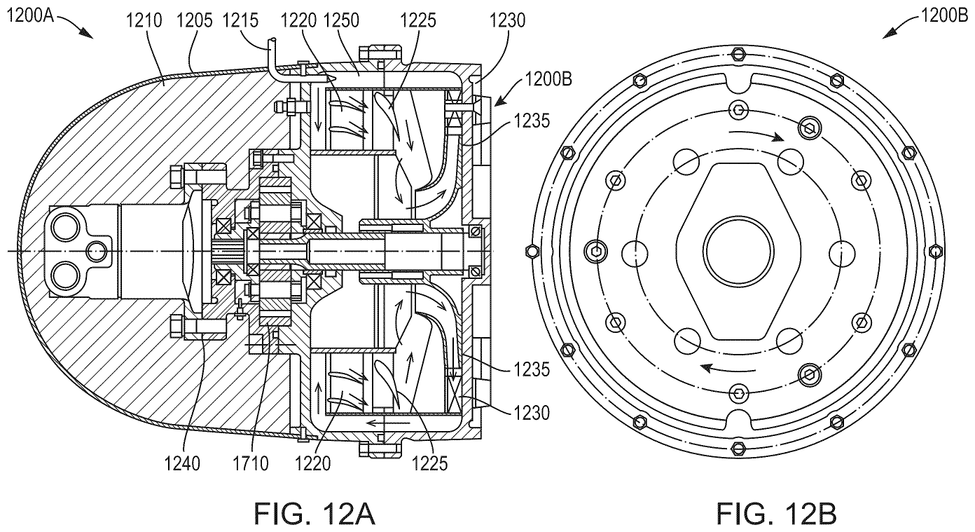

FIG. 12A is a view of an exemplary closed cycle lift force turbine with a direct drive, in accordance with an illustrative embodiment of the present invention;

FIG. 12B is a view of an exemplary end cover of a lift force turbine in accordance with an illustrative embodiment of the present invention;

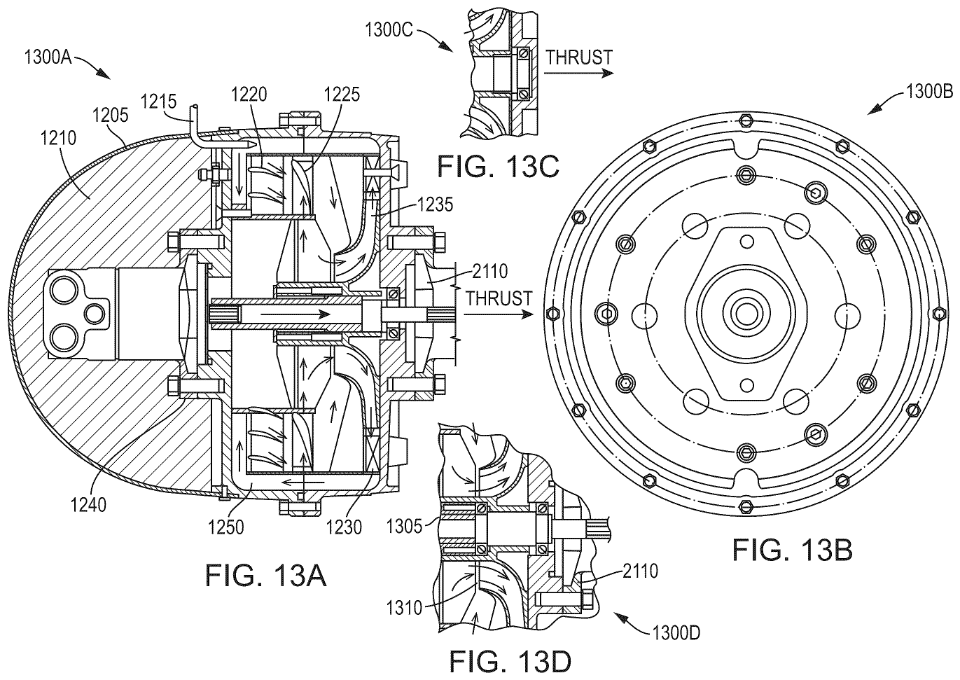

FIG. 13A is a perspective view of a simple gearless exemplary dual output direct drive closed cycle lift force turbine in accordance with an illustrative embodiment of the present invention;

FIG. 13B is a view of an exemplary end cover of a lift force turbine in accordance with an illustrative embodiment of the present invention;

FIG. 13C is partial view of a simple direct drive exemplary closed cycle lift force turbine in accordance with an illustrative embodiment of the present invention;

FIG. 13D is partial view of a vary drive exemplary closed cycle lift force turbine in accordance with an illustrative embodiment of the present invention;

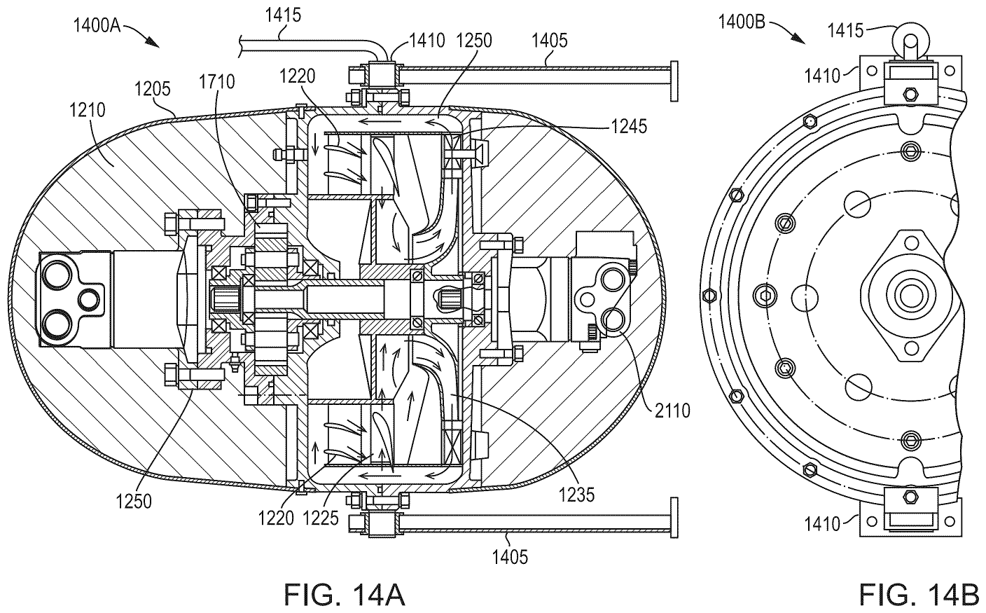

FIG. 14A is a perspective view of a geared exemplary closed cycle lift force turbine with a variable drive, in accordance with an illustrative embodiment of the present invention;

FIG. 14B is a view of an exemplary end cover of a lift force turbine in accordance with an illustrative embodiment of the present invention;

FIG. 15A is a diagram of an exemplary arrangement of blades of a lift turbine in accordance with an illustrative embodiment of the present invention;

FIG. 15B is a side view of an exemplary arrangement of blades of a lift turbine in accordance with an illustrative embodiment of the present invention;

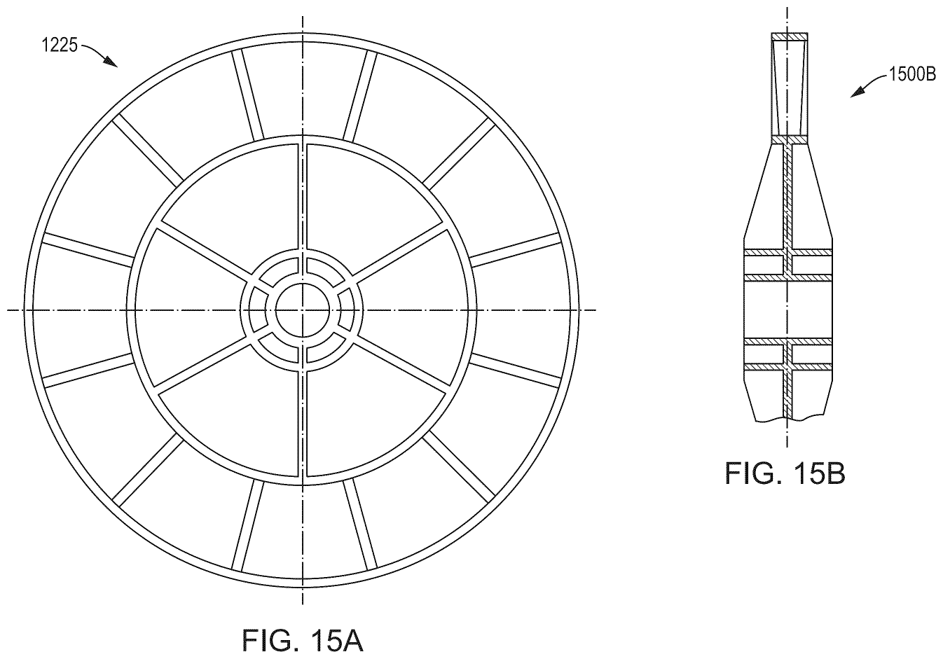

FIG. 16A is a forward view of exemplary blades for a lift turbine stator in accordance with an illustrative embodiment of the present invention;

FIG. 16B is an exemplary cross-sectional view of exemplary blades for a lift turbine stator in accordance with an illustrative embodiment of the present invention;

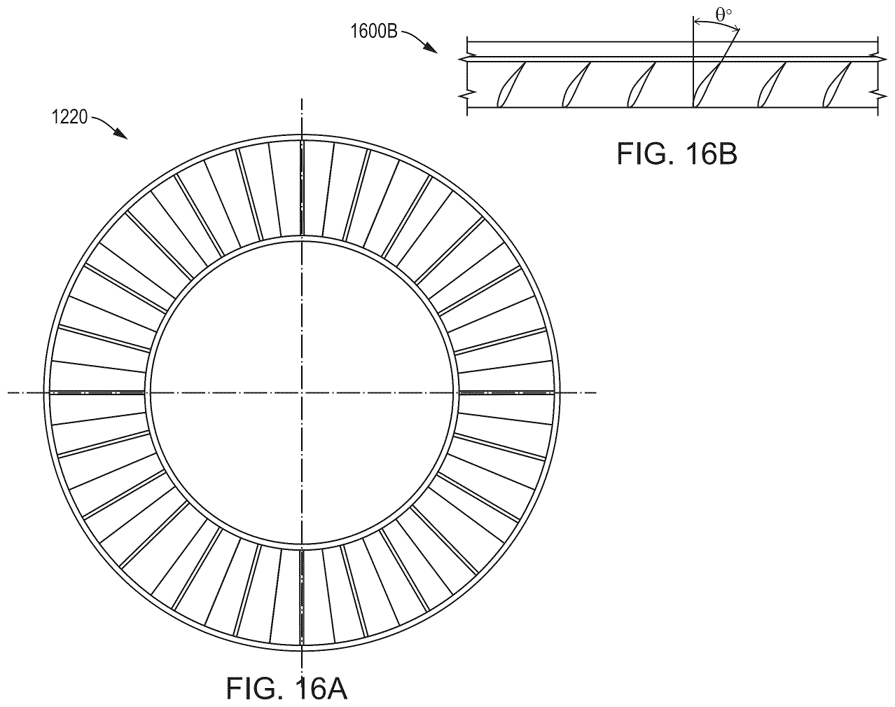

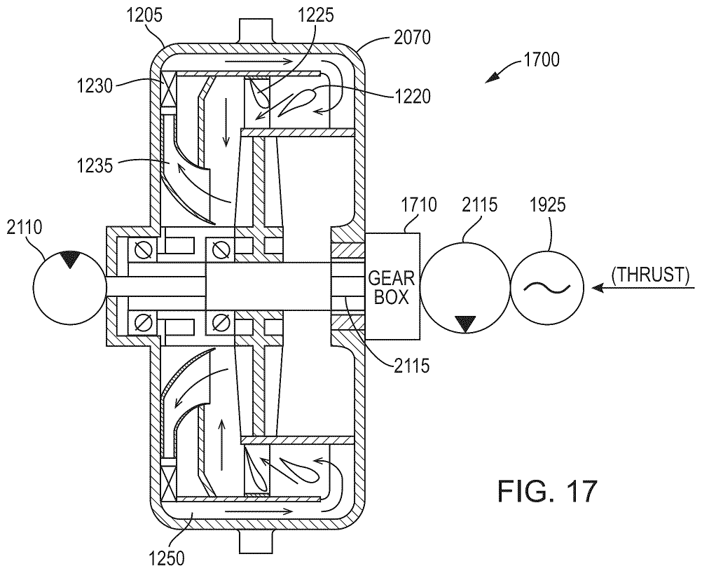

FIG. 17 is a cross-sectional diagram of an exemplary closed cycle lift force turbine with a variable drive, in accordance with an illustrative embodiment of the present invention;

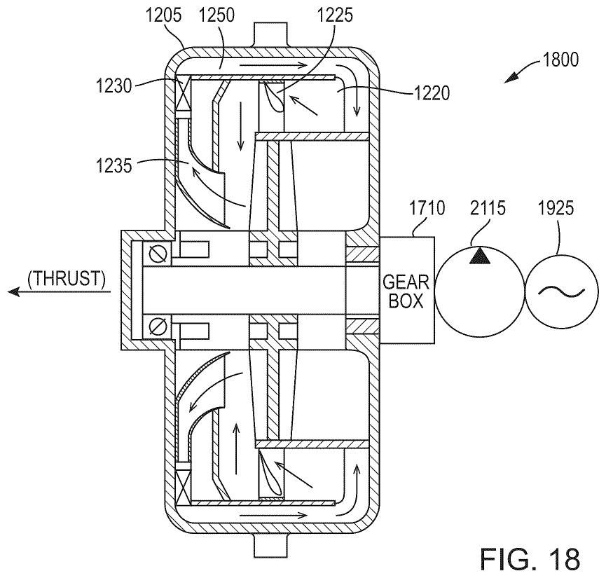

FIG. 18 is a cross-sectional diagram of an exemplary closed cycle lift force turbine with a fixed drive, in accordance with an illustrative embodiment of the present invention;

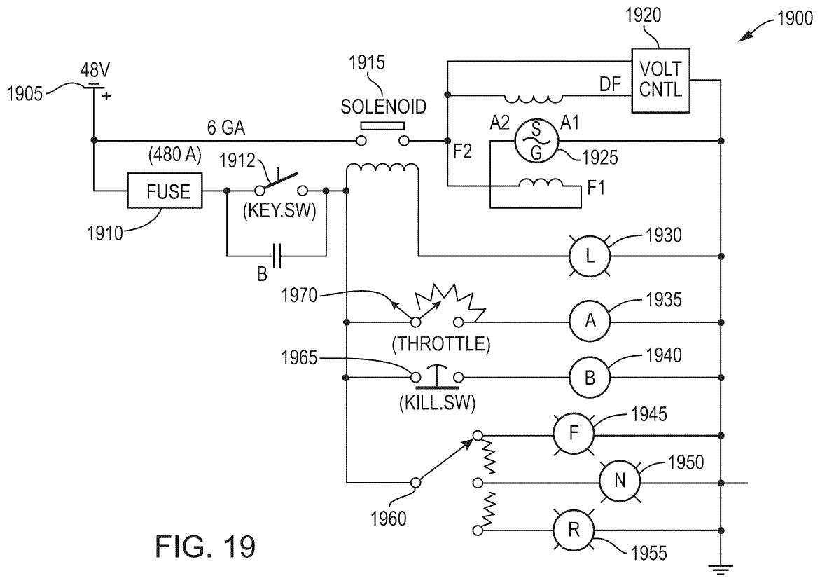

FIG. 19 is a schematic diagram of an exemplary general purpose electrical circuit for use with a lift force turbine in accordance with an illustrative embodiment of the present invention;

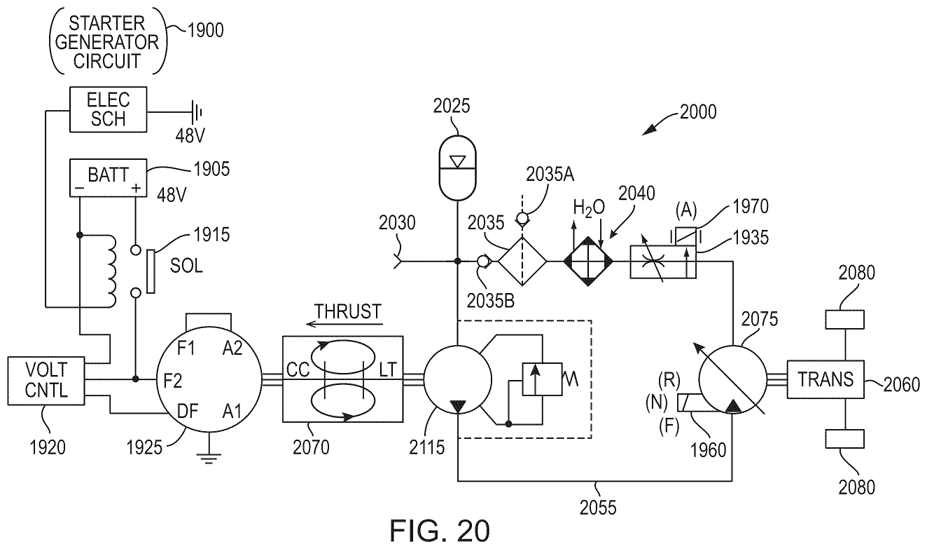

FIG. 20 is a schematic diagram of an exemplary hydraulic and electrical system for use with a lift force turbine in accordance with an illustrative embodiment of the present invention;

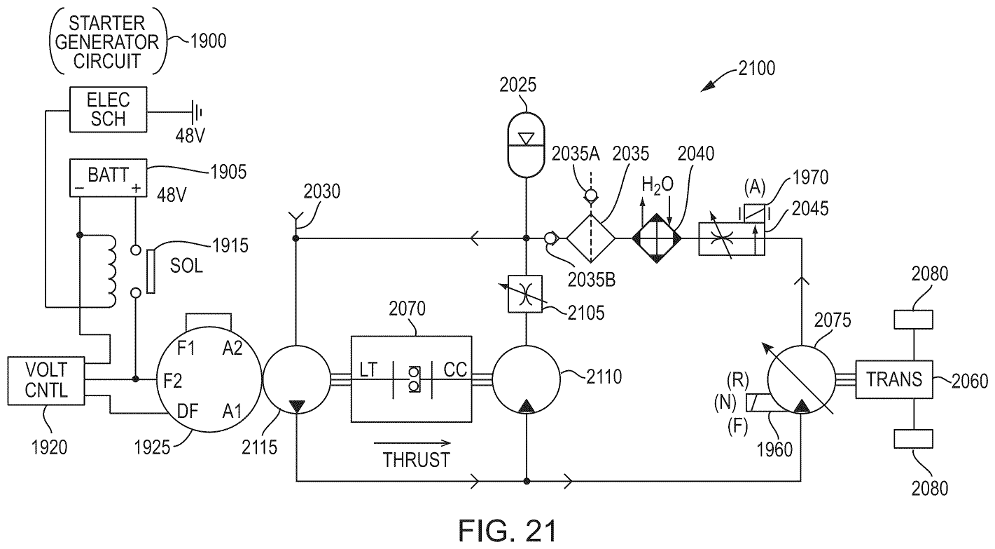

FIG. 21 is a schematic diagram of an exemplary hydraulic and electrical system for use with a lift force turbine in accordance with an illustrative embodiment of the present invention;

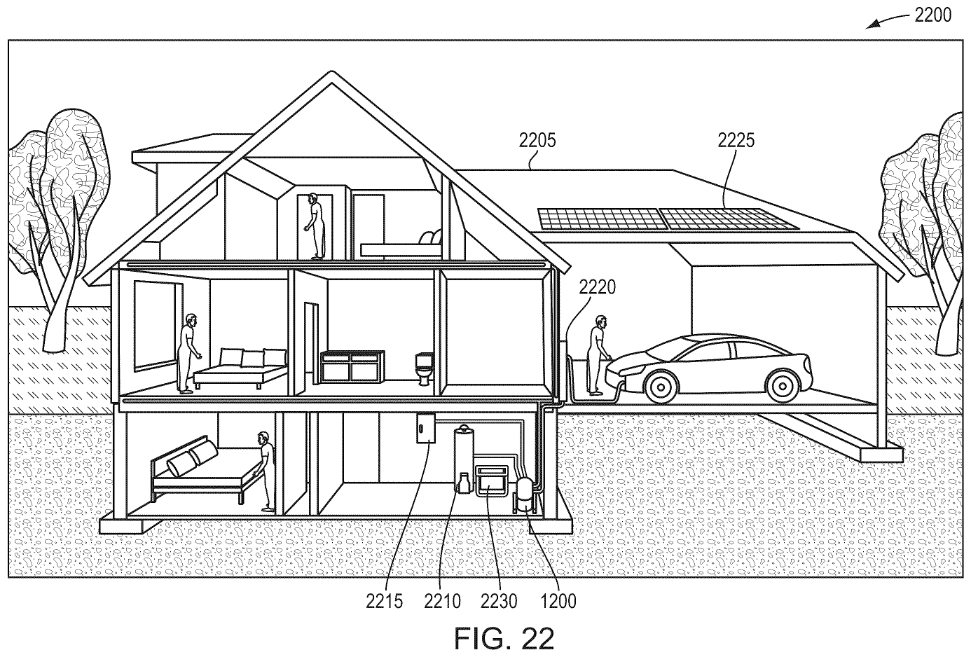

FIG. 22 is a cross-sectional view of an exemplary building using a lift force turbine as a power source in accordance with an illustrative embodiment of the present invention;

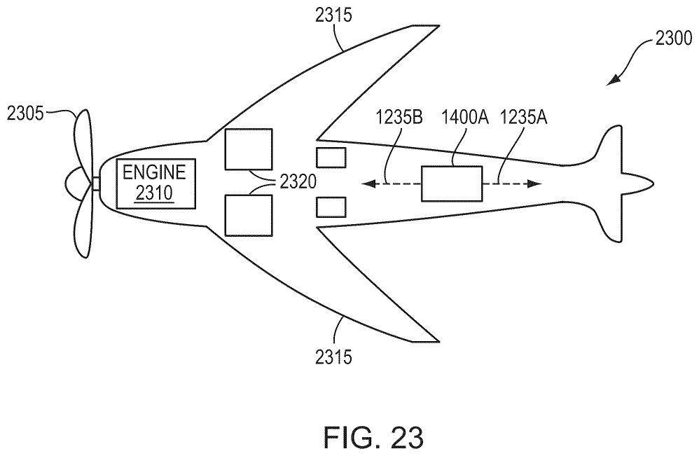

FIG. 23 is a cross-sectional view of an exemplary aircraft using a lift force turbine as a power source in accordance with an illustrative embodiment of the present invention; and

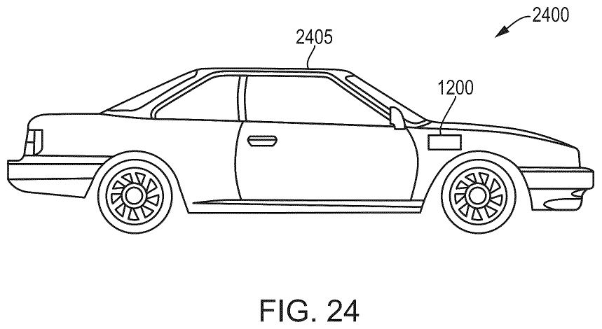

FIG. 24 is a cross-sectional view of an exemplary automobile using a lift force turbine as a power source in accordance with an illustrative embodiment of the present invention.

### DETAILED DESCRIPTION OF AN ILLUSTRATIVE EMBODIMENT

As noted above, Betz's Law conventionally states that the maximum efficiency of all machines designed to extract energy from a flowing stream (wind, water, or other fluid) is limited to 16/27 or approximately 59.3% of its kinetic energy by claiming that this is demanded by the law of conservation of energy. While Betz's Law appears to apply to existing machines, this appearance is coincidental and not causal. As noted above, conventional three bladed wind machines harvest, at best, approximately 6% of the total lift forces developed and 0% of the normal forces. The best or most efficient machines from low wind speeds up to approximately 18 miles an hour is still an old farm windmill, described above in relation to FIG. 1.

Typical farm windmills will rotate out of the wind stream at speeds above approximately 18 miles an hour. The blades on farm type windmills also harvest only a portion of the tangential component of the lift forces and are typically set at an approximately 45° angle for good start up torque with their speed regulated by the size of the pump load. When the blade speed exceeds the wind speed, the blades back wind and stall, thereby preventing the machine from ever reaching higher TSR's and resulting in higher power levels. Machines with blades set for higher TSR's will not start up, failing to reach operating speeds, mainly because of turbulent nulls, which causes back winding of the blades. The illustrative closed cycle lift force turbine of the present invention utilizes the normal component of the lift force as well as the tangential component to harvest a greater amount of energy from a flowing fluid, thereby resulting in a more efficient machine than conventional farm windmills and/or modern three bladed wind turbines.

Conventional and gas jet type machines are limited to the local atmospheric density, velocity, and oxygen content, where power is proportional to the air's density times the apparent wind velocity cubed. The closed cycle lift force turbine, operating according to these same rules, can well operate in any atmosphere or lack thereof, as it need not burn oxygen nor expel particles of any kind to produce thrust nor does it rely upon, nor is it influenced by, the ram jet air from the vehicles' speed.

Specifically, Betz's law is based on a simplified version of the Bernoulli Equation that is expressly only for incompressible non-rotational flows. This is a reasonable assumption for most conventional windmills. As will be appreciated by those skilled in the art, the validity of the Betz limit assumes that the Bernoulli Equation applies. It should be noted that Bernoulli himself said that it does not apply as wind turbines experience decidedly rotational flow. Moreover, a closed cycle lift force turbine made in accordance with various embodiments of the present invention creates and enhances highly rotational flows, which augment and reinforce the normal and tangential lift forces that are generated. Lift forces, which were not known in Bernoulli's or Newton's time, may be utilized to harvest a significantly greater amount of energy from the wind.

FIG. 3A is in an exemplary diagram illustrating the Bernoulli force in accordance with an illustrative embodiment of the present invention. As illustrated in FIG. 3A, the wind (or other fluid) V_{∞} engages a lever arm of a rotational device, such as a waterwheel. In such an environment, the fluid flow is transferred to rotational movement W. More generally, V_{∞} interacts with a lever arm and applies FB, i.e., a drag force, to the arm, which is translated into rotational movement. This is an example of the conversion of kinetic energy to potential energy and Newton's 3^{rd} Law.

FIG. 3B is an exemplary diagram illustrating the reaction force, i.e., momentum exchange, in accordance with an illustrative embodiment of the present invention. As illustrated in FIG. 3B, fluid flow (V_{∞}) causes a reaction force F_{R} when the fluid interacts with an angled surface causing it to rotate/move at velocity Vᵣ. This exchange forms the basis of conventional windmills and/or wind turbines. Bernoulli specifically excludes the applicability of his theory to devices of this type.

FIG. 3C is a diagram illustrating lift forces in accordance with an illustrative embodiment of the present invention. As illustrated in FIG. 3C a fluid flows (V_{∞}) over a shaped blade at a particular attack angle (∝) that generates lift forces F_{L} at right angles to the flow V_{∞}. Drag force F_{D} is also generated from the fluid impacting the blade. However, in typical embodiments the lift forces F_{L} are substantially greater than the drag forces F_{D} by a factor of at least 30 to 1 (F_{L}/F_{D}≥30:1). For example, Dr. Robert Liebeck has developed shaped blades, such as his Douglas/Liebeck LNV109A shape, that reportedly have L/D ratios exceeding 150:1. Currently, within conventional wisdom physics, there is no proper concept of, or a place for, a “Lift Force Energy”.

An exemplary closed cycle lift force turbine of the present invention illustratively utilizes lift forces to generate substantially more power density than a conventional wind turbine that only uses Bernoulli and/or reaction/drag forces. Further, the generation of lift forces creates an asymmetric pressure distribution on the blade and Newton's momentum exchange. After the apparent wind has imposed its asymmetrical pressure distribution upon the blades, it may either exit the machine and/or be internally recycled in a closed cycle. Closed Cycle machines are generally preferred as they are pressurized to operate at higher energy densities and utilize custom inert working fluids such as Helium to operate at higher speeds with a longer operating life. Conventional wisdom does not normally, if ever, differentiate these two, but my closed cycle lift force turbine almost exclusively utilizes the forces from this asymmetrical pressure distribution. Lift force was unknown and not predicted by either Bernoulli or Newton. They provided no guidelines on what energies may be extracted from a system using asymmetrical pressure distribution lift forces and since it is not a heat engine, the well-known laws of thermodynamics do not apply.

FIG. 4 is a perspective view of an exemplary horizontal axis lift turbine (HALT) 400 that illustrates certain features of a closed cycle lift force turbine (CCLFT) in accordance with an illustrative embodiment of the present invention. Illustratively, the HALT 400 exemplifies the advantages of pre-rotating and orientating a counter-rotating flow using stationary blades prior to the flow impacting rotating blades. With its precision closed loop hydraulic control system, a HALT is able to accurately control the winds' attack angle, alpha (a), upon the working blade, at all wind speeds, automatically. This counter-rotating and oriented pre-rotation compresses the range of the possible angles of attack of the flow (∝) on the rotating blades and combined with the fluid flow off the immediate previous blade energizing its most critically appropriate boundary layer, serves to avoid stalls should a momentarily lull, or spike, in the flow occur and which appears to contradict the universality of Newton's Third Law as well as the Conservation of Momentum Law, as the working blades rotate into the flow, with the same relationship to the apparent wind as that of ice boats and/or land yachts.

The HALT 400 is illustratively supported at an elevated position by tower 405. The exemplary tower 405 may be supported by a variety of types of bases in accordance with various alternative embodiments of the present invention. In one embodiment, tower 405 may be anchored to a base (not shown) that is permanently fixed. In an alternative embodiment of the present invention, tower 405 may be anchored to a pivoted base (not shown) that enables the tower to be moved between a raised position and a lowered position. An exemplary pivoted base may enable ease of maintenance, replacement, and/or repairs by enabling the HALT 400 to be lowered to a position closer to the ground. As will be appreciated by those skilled in the art, such a pivoted based would obviate the need for ladders or other lifting mechanisms to enable, for example, access to elements of the HALT for repair/maintenance purposes.

The HALT 400 illustratively comprises of a nacelle 450 that supports a nose dish 420, a plurality of rotating blades 410, a plurality of fixed blades 415, and a tail component 435. In addition to the rotating blades 410 and fixed blades 415, an exterior support structure 425 links the outer edges of each of the rotating blades 410. Illustratively, support 425 provides additional structural stability to the rotating blades 410. The tail component 435 is illustratively supported by a lateral support 430 that is operatively interconnected with a pole support 440. It should be noted that in alternative embodiments of the present invention, a HALT 400 may comprise additional and/or differing arrangement of components. As such, the description contained herein of specific components should be taken as exemplary only.

The nacelle 450 is illustratively mounted to tower 405 so that it may rotate to automatically face into the wind. As will be appreciated by those skilled in the art, various mechanisms, e.g., a bent axis positive displacement high efficiency hydraulic pump/motor capable of high speeds (not shown), etc., may be mounted in the nacelle 450 and directly operated by rotation of blades 410. One of the major insights in developing the exemplary HALT machine was the discovery of a simple automatic technique of getting the working blade rotor 410 to regularly and automatically track the wind speed in real time in a linear fashion.

The power of the wind varies as the cube of its velocity. If there is some device in its closed loop hydraulic control circuit which has a pressure drop proportional to the square of the fluids' velocity through it, which an orifice or needle valve readily and precisely does over an extended temperature range, the working blades rotor will/does track the wind speed in a linear fashion (1:1). Combined with a positive displacement hydraulic pump, the hydraulic fluid flow rate directly correlates in a linear fashion to the winds' speed. With the slow turning, large rotor of the HALT, it is quite easy to observe that it works very well at all wind speeds to control the wind's angle of attack on the blades. Illustratively, the HALT machine would not function properly without it. A similar system of closed loop control is used on the exemplary closed cycle lift force turbine described herein. With this fixed and working blade layout combined with the closed loop hydraulic control system, the HALT becomes a “tracked” machine, with its rotary motion very much similar to that of ice boats and/or land yachts with their linear motions, meaning that alpha, the apparent winds' attack angle and beta, the angle between the working blades' chord and allowed direction of motion are similar and precisely controlled for maximum effect at all wind speeds.

As noted above, the nacelle 450 of the HALT is illustratively mounted on tower 405 in a manner so that it may rotate to face the wind. In operation, the tail component operates to direct the rotating and fixed blades into the direction of the wind. Due to the robust design of the HALT and its control system, there is no need for the blades to rotate out of the wind at high wind speeds. Should the HALT experience the onset of ultrahigh winds, such as typhoons and/or hurricanes, the entire machine can be automatically and remotely lowered to the ground to be housed and protected. Such lowering may be accomplished by, for example, having a remotely controlled tower, by having a hinged tower that enables the assembly to be lowered, etc. Further, momentary gusts or drops in wind speed will not cause a loss of rotation as often occurs in prior art windmills or wind turbines. In accordance with illustrative embodiments of the present invention, the rotational system may include a braking and/or locking mechanism to cause the tower mounted components to be fixed in a particular location. This may be necessary, e.g., for maintenance purposes, or if the tower is foldable to ensure that when the tower is lowered to the ground various components of the HALT are not damaged by impacting the ground. However, as will be appreciated by those skilled in the art, in accordance with alternative embodiments of the present invention, no braking or other locking mechanism is utilized. As such, the description of a braking/locking mechanism should be taken as exemplary only.

In operation, the stationary blades 415 cause a counter-rotating oriented pre-rotation of the wind prior to interacting with rotating blades 410. Illustratively, this counter-rotating pre-rotation compresses the possible angles of attack of the wind or other fluid as it interacts with the rotating blades 410. Combined with the needle valve control and having its most critical boundary layer energized by trailing fluid flows from its immediately previous blade, this aims to provide a better more continuous lift force as well as prevent momentary stalls of the rotating blades due to lulls and/or spikes in the wind.

FIG. 5 is a rear view 500 of an exemplary HALT 400 in accordance with an illustrative embodiment of the present invention. View 500 illustrates the top portion of tower 405 and a view of the rear of the rotating blades 410 and support 425. Pole support 440 and lateral support 430 are illustrated as well as the tail component 435. The blade's chord is shown to be almost in the plane of rotation, with a negative beta between 0-15°'s, as this is known to be in theory as well as in practice, to be the position of maximum power harvestable for both the HALT as well as ice boats and/or land yachts.

One major difference between an exemplary HALT, ice boats, and land yachts as compared to conventional airplane wings and/or turbines, such as a jet engine and/or steam turbine, is that beta is negative as the rotating blades 410, (or sails as in the case of the ice boats, etc.) rotate (move) into the flow of the wind or other fluid in apparent violation of Newton's Third Law as well as the Conservation of Momentum Law. A jet, or gas engine, or other conventional turbine, such as the universally used steam power turbine, always rotates with the flow. As these are reaction or impulse machines, their blade rotation speed is invariably at slower speeds than the flow, e.g. TSR<1. This is different from the closed cycle lift force turbine's turbine, which always rotates at about 1-6 times the velocity of its oncoming flow, e.g. TSR>1. In effect, it is “making its own wind.” This pre-rotation of the fluid prior to impacting the rotating blades 410 helps to generate additional lift from the blades, as well as compresses the possible range of x, the wind attack angle, deteriorating the negative effects of spikes and nulls of normal turbulences in the working fluid.

FIG. 6 is a cross-sectional view 600 of an exemplary HALT in accordance with an illustrative embodiment of the present invention. Tower 405 is shown that supports a nacelle 450 that supports including fixed blades 415, rotating blades 410 as well as the tail structures 430, 435. The internals of the nacelle 450 are not shown. Nose dish 420 is mounted along a central axis of the HALT 400. Lateral support 430 as well as the pole support mechanism 440 are also illustrated. It should be noted that in accordance with an illustrative embodiment of the present invention, the rotating and fixed blades are disposed behind tower 405 when viewed from the direction of the wind (or other fluid). However, it should be noted that in alternative embodiments the fixed and/or rotating blades may be situated in front of tower 405. Further, in alternative embodiments the rotating blades may be behind, and the stationary blades may be in front of tower 405. As such, the description contained herein of fixed blades 415 and rotating blades 410 being located behind tower 405 should be taken as exemplary only.

FIG. 7 is a cross-sectional view 700 of an exemplary rotating blade that utilizes Dr. Robert Liebeck's LNV109A High Lift/Low Drag airfoil that may be utilized in accordance with an illustrative embodiment of the present invention. This particular blade profile is thought more appropriate as it has notably high surface curvature near its top nose half section with minimal aft concavity or curvature, which indicates that its extreme high lift/low drag (i.e., L/D) characteristics have more to do with front area asymmetrical pressure distribution from the relative surface curvatures rather than the Newton momentum exchange down draft explanation preferred by convention wisdom. Illustratively, a rotating blade having the cross-section shown in view 700 may be utilized with a HALT, as described above in reference to FIGS. 4-7, or in a closed cycle lift force turbine, as described further below. It should be noted that in alternative embodiments, differing cross sections may be utilized to achieve desired benefits. Therefore, the cross-section shown in view 700 should be taken as exemplary only and not limiting.

Chart 1 illustrates the dimensions based on percentages of an exemplary rotating blade chord in accordance with an illustrative embodiment of the present invention.

CHART 1

| NOSE RAD 3.22% of C (C= Chord, t =thickness) | | |
|---|---|---|
| X/C % | ±Y/C % | ±t/C % |
| 2.5 | .60 | 3.70 |
| 5.0 | 1.56 | 4.72 |
| 7.5 | 2.39 | 5.18 |
| 10 | 3.13 | 5.63 |
| 15 | 4.32 | 6.21 |
| 20 | 5.15 | 6.48 |
| 25 | 5.73 | 6.53 |
| 30 | 6.04 | 6.38 |
| 35 | 6.00 | 6.00 |
| 40 | 5.73 | 5.33 |
| 45 | 5.20 | 4.63 |
| 50 | 4.67 | 3.91 |
| 55 | 4.06 | 3.28 |
| 60 | 3.53 | 2.71 |
| 65 | 2.92 | 2.19 |
| 70 | 2.37 | 1.68 |
| 75 | 1.82 | 1.29 |
| 80 | 1.33 | .92 |
| 85 | .88 | .63 |
| 90 | .52 | .39 |
| 95 | .21 | .21 |
| 100 | .00 | .00 |

FIG. 8A is a chart of a detailed mathematical analysis illustrating the general tangential and normal components of the lift/drag forces on all aeronautical shapes and how these shapes must orientate to maintain a working angle of attack at various TSR's, from a TSR of zero to a TSR of approximately 6. This model is in accordance with an illustrative embodiment of the present invention. As shown in FIG. 8A, illustratively, the shape must rotate clockwise from a vertical position, shown at the upper far left corner, at zero TSR, to a horizontal orientation at a TSR of 6 at the far upper right corner. The normal component of the lift force steadily rises as the tip speed ratio (TSR) increases, but the tangential component, which is illustratively an order of magnitude smaller, goes steadily to zero when the TSR equals the L/D ratio. The power output of the tangential portion peaks at approximately half the maximum TSR, which then declines as the TSR increases, while the power output of the normal portion, if harvested, always increases with TSR. Similarly, torque on the blades, which is the tangential component, decreases with TSR and goes to zero at approximately TSR=L/D.

FIG. 8B is a diagram illustrating the asymmetrical nature of the lift forces on a blade detailing its tangential and normal components in accordance with an illustrative embodiment of the present invention. B is the angle between the chord of the airfoil shape and the allowed direction of motion. Conventional airplanes in level flight commonly operate with positive beta angles between 0-15 degrees, while a HALT and/or CCLFT as well as most high performance ice and land boats invariably operate with negative beta angles of 0-15 degrees. α is the angle between the apparent wind and the blade's chord and is positive in both cases.

As FIG. 8B illustrates, the local Lift Force elements, shaped by both the blades' local curvature and the apparent winds' angle of attack, are extremely asymmetrical and directional relative to the blade chord line. α and β are considered negative if they are counterclockwise (CCW) to this chord line and are considered positive if they are clockwise (CW). α is invariable positive in all known practical cases, but Beta is positive for airplanes in level flight to counter gravity but is generally negative for sailing machines to provide forward propulsion that don't need to contend with gravity. Additionally, on airplanes in level flight, α and β are both positive and aligned. This means generally that something must be burned to provide propulsion. This is in distinction to sailing machines, α and β are never aligned, but are purposely and carefully controlled and separated typically by 10° to 50°'s. If the Tangential Lift forces are greater than the opposing Drag Forces in the direction of desired/tracked motion, the object/machine will perpetually move accordingly. Competitive ice boats and Land Yachts, which are “tracked” vehicles, minimize their various drag components, while maximizing their Lift Force elements to satisfy this requirement. That is, if they are pushed to get started in even mild winds they will readily accelerate into the wind, making their own winds and will do so indefinitely.

FIG. 9A is an exemplary stator and blade layout used on both the HALT and the closed cycle lift force turbine. This exemplary blade layout is similar to that of ice boats and/or Land Yachts, showing the intimate interrelationships of the angles α, β, and Θ with exemplary blade positions and orientations of various components. On my HALT and CCLFT for best results, the blades do not necessarily have to overlap, but their flows preferably do, as the flow from the trailing edge of one works to energize the boundary layer of its succeeding blade, at the very area where it is most likely to separate at high angles of attack, allowing it to momentarily function at these very much higher attack angles. Conventional wisdom would, and does, indicate that for this circular blade array to exhibit a normal lift forcer in the observed direction, downstream of the oncoming flow, that the resultant downdraft would/must reverse back upon itself, which is a clear absurdity. Clearly this observed asymmetrical pressure Lift Force is a surface function and has more to do with the local blade curvature and the wind's angle of attack than to any interaction of Newton's 3^{rd} Law.

FIG. 9B is a graph of the influences on the various angles involved in the blade layout to the Coefficient of Power, (C_{power}) for both the HALT and the open cycle lift force turbine blade layout in accordance with an illustrative embodiment of the present invention.

FIG. 10A is a diagram illustrating an exemplary Golden triangle showing the compressed range of the attack angle alpha (∝) in accordance with an illustrative embodiment of the present invention.

FIG. 10B is a diagram illustrating how the apparent wind is enhanced by the redirected machine wind when used with a blade as described herein in accordance with an illustrative embodiment of the present invention. Since the power of the wind is proportional to the cube of the apparent wind, higher harvestable powers result from higher TSR's, explaining why linearly “tracked” ice boats and Land Yachts can exhibit such high speeds in low ambient winds. A CCLFT in accordance with various embodiments of the present invention uses these same techniques as a rotary “tracked” machine.

FIG. 11 is a chart 1100 illustrating changes in rotor speed verses micro wind. Line 1115 represents a typical older three bladed conventions turbine, line 1120 near it represents a more modern version. The lower curves are that of an open cycle lift force turbine or HALT in accordance with an illustrative embodiment of the present invention. Illustratively, the x-axis is linear time, while the y-axis is a wind speed in kilometers per hour (km/h). The lower chart illustrates wind speeds for both machines measured at fractional minute intervals (solid line) 1130 while the dotted line 1125 around it represents the HALT mean machine rotor speed (dashed line). Momentary spikes, such as exemplary spike 1105, may invoke blade stall and lulls, such as exemplary lull 1110, may invoke a blade back wind event in both machines. These changes, in the momentary wind, aka A Winds may put a conventional wind turbine into a momentary stall or cause a windmill or turbine to stop. The recovery of such a stall or stop may take on the order of one or more seconds. By the time such a recovery has occurred, a new micro wind event (e.g., spike or lull) may have occurred, which may result in further stalls, preventing the rotor from ever getting up to speed, causing a significant reduction in captured power. As can be readily seen, the HALT follows more closely the actual micro wind speed. Conventional wisdom using Newton's 3rd Law theory would say that this full blade array cannot work and would ascribe this non-functioning to be due to the full array overlapping blade layout blocking the blade's “downdraft;” however direct empirical observation and power measurements of the tangential lift force output of the HALT clearly disputes this notion. Clearly, there is another explanation of this observed Lift Force and that is that it apparently has to do with the local blade surface curvature and the wind's apparent angle of attack and not the “action at a distance” theory offered by various Newton's 3rd Law contenders.

The principles of the present invention may be utilized to overcome such problems with micro wind events. By counter pre-rotating and properly orientating the flow of the wind (or other fluid) prior to impacting with the rotating blades, and by moving several times faster than the speed of the wind, the maximum possible excursions of the wind attack angle upon the blades is compressed, preventing momentary lulls in the speed of the fluid to negatively affect the rotation of the turbine, e.g., a HALT or open cycle lift force turbine in various exemplary embodiments of the present invention works smoothly, despite always present local wind turbulences. In order to not become back winded, beta must become increasing small to accommodate.

Chart 1100 also illustrates an exemplary rotor revolutions per minute of an exemplary turbine. Illustratively, the RPM of the rotor may have momentary changes 1120, but overall maintains a substantially constant rate.

Illustrative embodiments of close cycle lift force turbines are described herein. For approximately 150 years, practitioners of ice boating and land sailing, known by the practitioners as Land Yachts, i.e. ice boats on wheels versus blades, have known informally that properly designed and sailed machines can avoid the effects of the always present spikes and lulls in the turbulent winds by literally “making their own wind” while harvesting only the tangential component of the lift force. That is, even on almost windless days, if these machines are manually pushed to get started, they will and can readily accelerate up to approximately seven times the speed of the wind, i.e., TSR=˜7. Observationally, the lift force power producing output for these machines with some sail shapes at some wind angles of attack is or rather can be greater than the opposing wind drag and friction forces and energies encountered at these speeds. These machines are capable of continuous movement once started. These machines harvest only the tangential portion of the Lift Forces generated and are not designed for producing general purpose power.

The CCLFT of the present invention, operating with similar blade shapes, Beta angles and Alpha angles of attack is designed for such general-purpose power generation from the tangential portion of the Lift Forces, as well harvesting the normal component of the Lift Forces for direct thrust that are not harvested by the ice boats and land yachts nor by the stationary conventional 3-bladed utility scale wind machines.

The various embodiments of the CCLFT are self-contained engine/turbine specifically designed to operate similarly to ice boats and more. A CCLFT is more efficient as it can dramatically increase both the actual wind and the apparent wind's speed, pressurize the system for greater energy density, and use the centrifugal compressor's diffuser to convert the kinetic energy to pressure energy to lessen the frictional losses around the CCLFT. In operation, the CCLFT of the present invention utilized both the tangential portion of the lift forces generated as well as the much larger normal component.

A CCLFT made in accordance with embodiments of the present invention may be used to replace not only conventional fossil fuel powered devices, but also all heat engines and/or all of the renewables, being not intermittent nor site dependent and having much higher energy densities facilitating lower manufacturing and material costs. Nuclear, hoped-for fusion, large scale battery storage, hydro powered and all systems requiring stored fuel systems are expected to be similarly challenged. A noted advantage of a CCLFT is that they do not require significant amounts of water, either to cool the device or as a working fluid. As will be appreciated by those skilled in the art, most power generation systems (coal and gas power plants, nuclear power plants, etc.) operate to boil water to steam, which may then be used to power a steam turbine. A CCLFT avoids the need for both water and steam turbines.

Similarly, as described further below, a CCLFT may be used to power an automobile, including, e.g., a semi, by replacing the diesel engine. Using a CCLFT may save over $100,000 in fuel costs per year per semi. As there are approximately four million diesel semis in the United States, the cost savings can be significant. Additionally, a reduction in airborne pollutants would arise, with benefits to reducing pollution as well as potential health care costs. Utilizing the CCLFT, fixing climate change can be overwhelmingly cost-effective versus the fossil fuel fueled alternative.

FIG. 12A is a view of a geared output exemplary closed cycle lift force turbine 1200A with a direct drive turbine to compressor arrangement in accordance with an illustrative embodiment of the present invention. Exemplary CCLFT 1200A is shown in cross-section in FIG. 12A. An exemplary cover 1205 and sound insulation provide sound dampening for the CCLFT.

Illustratively, the closed cycle lift force turbine 1200A is illustratively comprised of a lift turbine stator 1220, a lift turbine 1225, and a centrifugal compressor 1235 and associated diffuser 1230. The inlet to the centrifugal compressor 1235 is illustratively located immediately after the lift turbine 1225. The inlet creates a low-pressure region sucking the flow out of the lift turbine, speeding it up to a maximum at its outermost point where it enters the diffuser 1230 which converts this high velocity kinetic energy into higher pressure, but much lower velocity, potential energy as it travels through an outside return path 1250 towards the lift turbine. This flow later expands as it passes through the relatively small gap between the trailing edge of one blade energizing the boundary layer of its succeeding blade in the very area where flow from high angles of attack is most likely to separate from the working blade allowing it to function at higher-than-normal angles of attack. On the side of the lower lift turbine structure facing the input to the centrifugal compressor are radial ribs that help bring the rotating fluid's velocity up to the rotations per minute (RPM) of the input to the centrifugal compressor.

Illustratively, high fluid velocities only exist in two places within the system: (1) where they are created at the exit from the centrifugal compressor, and (2) around the high lift areas of the working blades where they are used. In all other areas, primarily to reduce frictional flow loses, this velocity is lowered, either by being converted into potential energy or geometry to minimize potential frictional flow loses. Additionally, this flow conversion from high velocities to potential energies reduces the necessary size of the various channels, reducing the size and weight of the machine and therefore allowing the increase to its energy density and generally lower its cost to manufacture.

In accordance with illustrative embodiments of the present invention, a direct drive turbine to compressor embodiment is presented where the lift turbine and the centrifugal compressor are pressed onto the same shaft. These components therefore rotate as one piece.

A gear driven hydraulic pump 1240 may be operated by the turbine to enable the CCLFT to be used for energy production, as described further below.

FIG. 12B is an end view 1200B of a closed cycle lift force turbine in accordance with an illustrative embodiment of the present invention. Exemplary housing half 1200B provides for separating the CCLFT to allow access for maintenance, etc. It also illustratively provides a secure seal to enable the CCLFT 1200A to be pressurized.

FIG. 13A is a perspective view of a simpler lower powered gearless driven exemplary closed cycle lift force turbine 1300A with a secondary output/input on its right-hand end in accordance with an illustrative embodiment of the present invention. CCLFT 1300A is similar to CCLFT 1200A, but less the geared output/input, 1710. CCLFT 1300A is an illustrative direct drive turbine to compressor embodiment.

FIG. 13B is an end view 1300B of a lift force turbine 1300A in accordance with an illustrative embodiment of the present invention.

FIG. 13C is partial view 1300C of an exemplary simpler single input/output closed cycle lift force turbine in accordance with an illustrative embodiment of the present invention.

FIG. 13D is partial view 1300D of an exemplary vary-driven turbine to compressor closed cycle lift force turbine in accordance with an illustrative embodiment of the present invention. FIG. 14A is a perspective view of a geared input/output exemplary closed cycle vary-driven turbine to compressor lift force turbine 1400A with a variable drive, in accordance with an illustrative embodiment of the present invention. Exemplary CCLFT 1400B is mounted on a set of supports 1405 and is configured to rotate at pivot points 1410. Illustratively, a handle 1415 is provided that enables a user to manually rotate the CCLFT. It should be noted that in alternative embodiments, CCLFT may be rotated by electro-mechanical techniques. Therefore, the description of manually rotating CCLFT should be taken as exemplary only. CCLFT may be configured to rotate so that it may provide thrust in differing directions when mounted on a vehicle for example. While CCLFT 1400B is shown being rotatable, it may be fixed in alternative embodiments of the present invention.

FIG. 14B is an end view 1400B of a lift force turbine 1400A in accordance with an illustrative embodiment of the present invention. FIG. 14B provides an alternative view of pivot points 1401 and handle 1415.

FIGS. 15A, B are diagrams of an exemplary arrangement of blades of a lift turbine 1225 in accordance with an illustrative embodiment of the present invention. Illustratively, the blades are tapered with no twist. The blades have no twist to maximize the boundary layer energization occurring blade to blade.

FIG. 16A is a forward view 1600A of exemplary blades for a lift turbine stator 1220 in accordance with an illustrative embodiment of the present invention. Similar to blades for the lift turbine, these blades are tapered, but optionally with no twist.

FIG. 16B is an exemplary cross-sectional view 1600B of exemplary blades for a lift turbine stator 1220 in accordance with an illustrative embodiment of the present invention. View 1600B provides an illustration of the arrangement of the blades of the lift turbine stator 1220 in accordance with an illustrative embodiment of the present invention.

FIG. 17 is a cross-sectional diagram of a geared input/output exemplary closed cycle lift force turbine 1700 with a variable drive lift turbine to compressor, in accordance with an illustrative embodiment of the present invention. FIG. 17 is a simplified view of the previous figures to show a CCLFT in conjunction with other operating elements. CCLFT 1700 is operatively connected with a centrifugal compressor hydraulic motor 2110 (described below in relation to FIG. 21) that may be operated by the CCLFT. A gear box 1710 is operatively interconnected with the CCLFT and a pump 2115, which is further operatively interconnected with a starter generator 1925.

In operation, the starter generator 1925 is connected to the Lift Turbine 1225 by a geared through shaft and directly to the pump 2115. Once the starter generator 1925 gets the Lift turbine 1225 up to operating speed, it then drives the starter generator charging whatever batteries are connected to it and/or the pump 2115, which in turn, drives various output devices such as a vehicle's transmission and/or speed control devices in its circuit. Pump 2115 is illustratively also hydraulically connected to motor 2110. Motor 2110 independently drives centrifugal compressor 1235; its speed is controlled by hydraulic needle valve 2105 (FIG. 21).

FIG. 18 is a cross-sectional diagram of an exemplary gear driven input/output pump 2115 closed cycle lift force turbine 1800 with a fixed Lift Turbine, 1225 to compressor, 1235 drive, in accordance with an illustrative embodiment of the present invention. Similar to FIG. 17, the CCLFT is operatively interconnected with a gear box 1710 that is further connected with a pump 2115 and starter generator 1925. It should be noted that while FIG. 17 illustrates a variable Lift Turbine, 1225, to compressor, 1235, drive driven by motor 2110 and FIG. 18 illustrates a fixed drive, both providing thrust, these are illustrative only. All Lift Turbines in operating CCLFT's will produce a Normal component thrust without discharging particles of any kind and independent of the Hydraulic Tangential component output, but in some stationary applications, it is pointed harmlessly towards the earth or restrained bolted to a frame. In alternative embodiments, fixed Lift Turbine to compressor drive CCLFT's may operate a motor and other hydraulically connected attachments and may optionally be used to provide thrust. As such, the description contained herein should be taken as exemplary only.

FIG. 19 is a schematic diagram of an exemplary general purpose battery charging electrical circuit 1900 for use with a lift force turbine in accordance with an illustrative embodiment of the present invention. The electrical circuit may be utilized with the CCLFT to generally control and vary its hydraulic power output and direction of thrust. The circuit 1900 comprises a battery 1905 connected with a fuse 1910 that leads to a key switch 1912. A solenoid 1915 is connected to a starter generator 1925 and a voltage controller 1920. The starter generator 1925 is utilized to provide initial power to a CCLFT to spin it up so that it is operating. Once operating, the CCLFT will no longer require the starter function, but the generator 1925 may be continued to function to charge up a larger battery pack, such as a house “power wall” or any place it is desired to charge batteries, be it for work, a business, a camp site, mobile home, boat, airplane or military installation, etc.

The key switch 1912 provides power to light 1930, a throttle 1970, kill switch 1965, and an electric transmission valve 1960. Light 1930 provides a visual on/off indication for the CCLFT. Throttle 1970 controls throttle needle valve 1935 to control the speed of the CCLFT. Kill switch 1965 controls kill switch valve 1940 to turn off the CCLFT in an emergency. Variable electrical Valve 1960 controls variable swash plate hydraulic motor 2075 to provide infinitely adjustable forward 1945, neutral 1950 or reverse 1955 transmission motion on demand with lights 1945, 1959 & 1955 to indicate selection, respectively.

FIG. 20 is a schematic diagram of an exemplary hydraulic and electrical system 2000 for use with a lift force turbine in accordance with an illustrative embodiment of the present invention. Illustrative system 2000 may be used to drive a vehicular load, such as an automobile, semi-truck, bus, boat, airplane, air conditioner or power a house, etc. A battery 1905 provides power to a solenoid 1915 that feeds into a voltage controller 1920. The voltage controller 1920 is connected to a starter generator motor 1925 that is used to initiate the turbine assembly 2070.

Once the turbine (CCLFT) is operational, the resultant Tangential component of the Lift Force is used to power pump 2050 to provide hydraulic fluid through piping/hoses to a transmission 2060 via motor 2075. Transmission 2060 may drive one or more wheels 2080 to provide propulsion to a vehicle. In alternative embodiments, wheels 2080 may be replaced by a propellor for a marine or airplane environment. The Normal component of the Lift Force provides direct thrust to the frame of the vehicle in which it is mounted and is not transmitted through the transmission 2060 drive train or the wheels, extending the life of these elements.

An accumulator 2025 may be used to provide make up storage of hydraulic fluid against loses and/or thermo expansions, but its main purpose is to provide fluid to the pump 2050, so that its working fluid does not cavitate, especially during high speed and or rapidly changing operation. A Quick connector 2030 is provided to conveniently periodically restock the system with lost fluid, as well as a system filter 2035 and a gas vent valve 2035A to vent occasional cavitational gases. Illustratively, an air or liquid heat exchanger 2040 is provided to cool the hydraulic working fluid. A throttle valve 1935 is provided, electrically controlled by Throttle-solenoid 1970.

FIG. 21 is a schematic diagram of an exemplary hydraulic and electrical system 2100 for use with a lift force turbine in accordance with an illustrative embodiment of the present invention. System 2100 is similar to system 2000, however a pump 2115 is on a common shaft with and located between starter generator 1925 and the turbine assembly 2070. Motor 2110 separately vary-drive powers the centrifugal compressor via excess hydraulic fluid from CCLFT pump 2115, whose speed is independently governed/regulated by needle valve 2015 before heading back to join the return circuit, by-passing filter 2031 on this trip. The main flow from pump 2115 that by-passes motor 2110 travels first to the swash plate motor 2075 governed by electrically controlled valve 1960. Motor 2075 provides power to transmission 2060 to turn wheels 2080 or, as noted above, propellors in marine environments. From the motor 2075, the fluid flows through the main speed control valve 1935 controlled by electric throttle 1970, then to the heat exchanger 2040 then through the system filter 2035, exiting gas through gas vent valve 2035A, thru check valve 2035B, past accumulator 2025 and quick connector 2030 to return to main pump 2115.

FIG. 22 is a cross-sectional view 2200 of an exemplary building 2205 using a lift force turbine as a power source in accordance with an illustrative embodiment of the present invention. View 2200 illustrates a residential home 2205; however, it should be noted that the principles of the present invention may be used in other types of buildings. Therefore, the description of a residence should be taken as exemplary only.

Exemplary building 2205 has a CCLFT 1200 installed. While CCLFT 1200 is shown as a direct drive system, variable-drive systems may be utilized in alternative embodiments. An alternative and possibly more economical arrangement would be for the CCLFT 1200 to be located in the vehicle 2405, eliminating wall charger 2220 with the battery/power store 2230 and balance of system to be located in the house/building. Exemplary CCLFT is utilized to provide electrical power and/or hydraulic power to, inter alia, hot water heater 2210, electrical junction box 2215, electric vehicle charging point 2220, and battery/power store 2230.

In operation, the CCLFT provides sufficient energy (electrical and/or hydraulic power) to run the normal systems of building 2205, mobile home, houseboat, airplane, work or campsite, etc. It may be augmented by exemplary solar panels 2225 in alternative embodiments. Battery 2230 may provide sufficient power to start the CCLFT, but once it is operational, the CCLFT recharges it and may continue to run to provide energy to the building. In alternative embodiments, it may power differing and/or other devices, e.g., direct hydraulic powered heat pumps and/or air conditioning/refrigeration systems, pool heaters, etc.

FIG. 23 is a schematic view of an exemplary aircraft 2300 using a lift force turbine as a power source in accordance with an illustrative embodiment of the present invention. Illustratively, aircraft 2300 is a propeller 2305 drive aircraft powered by conventional engine 2310; however, in alternative embodiments, it may be a jet (or other) powered aircraft.

Therefore, depiction of aircraft of being propeller drive should be taken as exemplary only. Exemplary CCLFT 1400A is mounted in aircraft 2300. Similar to FIG. 2000, the hydraulic transmission could be connected to assist the engine 2310 to drive propeller 2305 with the direct thrust of the CCLFT assisting forward motion during taking off via 1235B or retarding motion via 1235A, during landing. The principles of the present invention may be utilized with a variable drive model, e.g., CCLFT 2100. Therefore, the depiction of a direct drive CCLFT 1200 should be taken as exemplary only.

Exemplary CCLFT 1400A is mounted so that it is rotatable to provide thrust either aft 1235A or forwards 1235B or upwards to directly counter gravity for vertical takeoff electric taxi drones, etc. In operation, conventional engine 2310 may provide sufficient thrust for takeoff and/or landing operations. CCLFT 1200 may then be utilized to provide thrust during cruise operations. In this manner, the total amount of fuel used by engine 2310 may be significantly reduced. In alternative embodiments, CCLFT may provide sufficient thrust for takeoff and/or landing operations, thereby obviating the need for a conventional engine 2310.

It should be noted that while FIG. 23 illustrates an aircraft, the principles of the present invention may be utilized in a spacecraft. Therefore, the description of an aircraft should be taken as exemplary only. The fact that a CCLFT does not require any continuing use of fuel makes one ideal for use in a spacecraft as the need to carry large quantities of fuel is eliminated. Additionally in both cases, not having to lug around the weight and bulk of large quantities of fuel, can significantly increase possible acceleration/deceleration motions as well as increase the payload and/or economic viabilities of the vehicle involved, not to mention minimizing safety issues with same.

FIG. 24 is a side view 2400 of an exemplary automobile 2405 using a closed cycle lift force turbine 1200 as a power source in accordance with an illustrative embodiment of the present invention. In such an embodiment, the CCLFT may be utilized to directly hydraulically drive a transmission such as 2060 and provide direct thrust to the automobile frame and/or may be used to generate electricity to power electric motors for propulsion of the vehicle and/or provide electric power to the nearby household/campsite.

The above description has been written in terms of various exemplary embodiments. Therefore, it is intended that all matter contained in the above description or shown in the accompanying drawings should be interpreted as illustrative and not in a limiting sense. Specifically, it should be noted that each of the various sizes, degrees of overlap, materials, number of blades, etc. described and/or shown should be viewed as exemplary and not limiting the scope of the present invention. As will be appreciated by those skilled in the art, the principles of the present invention may be utilized with a variety of materials, sizes, and/or objectives.

It should be noted that while various descriptions and arrangement of components have been described herein providing electricity, heat, hot water, and/or air conditioning, the principles of the present invention may be utilized in a wide variety of systems. As such, the description of particular arrangements of components should be taken as exemplary only. It should be expressly noted that in alternative embodiments, a CCLFT system may be configured to provide only hot water, electricity, or heat, or any combination thereof. As will be appreciated by those skilled in the art, the principles of the present invention for the description contained herein may have unnecessary components removed to meet the desired objectives of a particular installation.

1. An apparatus comprising:
a closed cycle lift turbine assembly operatively interconnected with a centrifugal compressor assembly, the lift turbine assembly and the centrifugal compressor assembly being housed within a closed pressurizable container filled with a flow through gas;
the lift turbine assembly including:
(a) an input stator having a first set of blades, the first set of blades causing a counter rotation flow in the gas;
(b) a lift turbine having a second set of blades, the second set of blades generating lift force, the second set of blades rotating into the counter rotation flow of the gas; and
the centrifugal compressor assembly including a centrifugal flow diffuser.

2. The apparatus of claim 1 wherein the apparatus provides continuous thrust and power in an atmosphere without burning a fuel.

3. The apparatus of claim 2 wherein the continuous thrust and power after startup is independent of a speed of a vehicle in which it is mounted.

4. The apparatus of claim 2 wherein the continuous thrust and power after startup is independent of a local atmosphere associated with a vehicle in which it is mounted.

5. The apparatus of claim 1 wherein the apparatus provides continuous thrust and power in no atmosphere without burning a fuel.

6. The apparatus of claim 1 wherein rotation of the lift turbine operates a pump.

7. The apparatus of claim 7 wherein the pump drives hydraulic fluid, the hydraulic fluid operating a machine.

8. The apparatus of claim 7 wherein the machine is a heat exchanger.

9. The apparatus of claim 7 wherein the machine is an electric generator.

10. The apparatus of claim 7 wherein the machine is a pressurized accumulator.

11. The apparatus of claim 1 wherein the flow through gas does not contain oxygen.

12. The apparatus of claim 1 wherein the gas remains at a substantially steady but varying pressure throughout the apparatus.

13. The apparatus of claim 1 wherein the overall container is substantially tubular in shape.

14. The apparatus of claim 1 wherein the gas is helium.

15. The apparatus of claim 1 wherein the gas remains at a substantially steady but varying temperature.

16. The apparatus of claim 1 wherein the lift turbine and the centrifugal compressor rotate as a single unit.

17. The apparatus of claim 1 wherein the lift turbine and the centrifugal compressor rotate as separate units.

18. The apparatus of claim 1 wherein a normal component of the generated lift force is used to generate thrust.

19. The apparatus of claim 1 wherein a portion of a tangential lift force also provides thrust.

20. The apparatus of claim 1 wherein a lift to drag ratio (L/D) of the lift turbine is greater than 1:1.

21. The apparatus of claim 20 wherein the L/D is approximately 150:1.

22. The apparatus of claim 1 wherein a tip speed ratio of the lift turbine is greater than 1:1.

23. The apparatus of claim 1 wherein the apparatus provides continuous thrust and power in an atmosphere without expelling any particles.

24. The apparatus of claim 1 wherein the apparatus provides continuous thrust and power in no atmosphere without expelling any particles.

25. The apparatus of claim 1 wherein the apparatus provides continuous thrust and power in an atmosphere without heat.

26. The apparatus of claim 1 wherein the apparatus provides continuous thrust and power in no atmosphere without heat.

27. The apparatus of claim 1 wherein the apparatus provides continuous thrust and power in an atmosphere with the Lift Turbine operating at negative (CCW) Beta angles.

28. The apparatus of claim 1 wherein the apparatus provides continuous thrust and power in no atmosphere with the Lift Turbine operating at negative (CCW) Beta angles.

29. The apparatus of claim 1 wherein the apparatus provides varying torque output at constant RPM output by varying the pressure of the flow through gas.

30. The apparatus of claim 1 wherein the apparatus provides varying torque output at constant RPM output by varying the speed of the flow through gas.

31. The apparatus of claim 1 wherein the apparatus provides varying thrust output at constant RPM output by varying the pressure of the flow through gas.

32. The apparatus of claim 1 wherein the apparatus provides varying thrust output at constant RPM output by varying the speed of the flow through gas.

33. The apparatus of claim 1 wherein the apparatus provides varying RPM output at constant thrust output by varying the pressure of the flow through gas.

34. The apparatus of claim 1 wherein the apparatus provides varying RPM output at constant thrust output by varying the speed of the flow through gas.
